(19) United States
(12) Patent Application Publication
(10) Pub. No.: US 2015/0077635 A1
(43) Pub. Date: Mar. 19, 2015

(54) METHOD FOR OUTPUTTING MULTIPLE MULTIMEDIA TRACKS ALONG MULTIPLE PROCESSING PATHS FROM A PORTABLE ELECTRONIC DEVICE

(71) Applicant: HTC Corporation, Taoyuan City (TW)

(72) Inventors: Chao-Nan WU, Taoyuan City (TW); Kuei-Sung YU, Taoyuan City (TW); Yi-Chiu CHAN, Taoyuan City (TW); Chia-Wei CHIU, Taoyuan City (TW)

(73) Assignee: HTC Corporation, Taoyuan City (TW)

(21) Appl. No.: 14/030,654

(22) Filed: Sep. 18, 2013

(51) Int. Cl. H04N 5/60; H04N 5/44

(52) U.S. Cl. CPC H04N 5/602; H04N 5/4401
USPC 348/552

(57) ABSTRACT

A method for outputting multiple multimedia tracks along multiple processing paths from a portable electronic device is provided. The method has the steps of: running at least two applications on the portable electronic device; accessing at least two multimedia tracks corresponding to the at least two applications; processing the at least two multimedia tracks along at least two processing paths; transferring the at least two multimedia tracks to at least two output terminals; and playing the at least two multimedia tracks by the at least two output terminals; wherein at least one of the at least two output terminals is external to the portable electronic device.

### BACKGROUND OF THE INVENTION

1. Field of the Invention

The present invention relates audio processing, and in particular, to a portable electronic device and a method for outputting multiple multimedia tracks along multiple processing paths.

2. Description of the Related Art

With advances in technologies, portable electronic devices such as smartphones and tablet PCs have become widely used. However, due to limited resources, multimedia tracks (e.g. audio signals and/or image signals) of applications running on a conventional portable electronic device are usually processed by the same processing thread. As a result, when the content of the conventional portable electronic device is mirrored to an external device, it is very inconvenient for the user since the audio signals of all the applications will be mirrored to the external device without being controlled separately and independently.

### BRIEF SUMMARY OF THE INVENTION

A detailed description is given in the following embodiments with reference to the accompanying drawings.

In an exemplary embodiment, a method for outputting multiple multimedia tracks along multiple processing paths from a portable electronic device is provided. The method has the steps of: running at least two applications on the portable electronic device; accessing at least two multimedia tracks corresponding to the at least two applications; processing the at least two multimedia tracks along at least two processing paths; transferring the at least two multimedia tracks to at least two output terminals; and playing the at least two multimedia track by the at least two output terminals; wherein at least one of the at least two output terminals is external to the portable electronic device.

In another exemplary embodiment, a method for outputting multiple multimedia tracks along multiple processing paths from a portable electronic device is provided. The method has the steps of: running a first application on the portable electronic device; processing a first multimedia track corresponding to the first application along a first processing path; outputting the first multimedia track to a first multimedia output terminal; launching a second application during running of the first application on the portable electronic device; receiving a first user input for selecting a second multimedia output terminal corresponding to the second application; processing a second multimedia track corresponding to the second application along a second processing path according to the first user input; and outputting the second multimedia track to the second multimedia output terminal, wherein one of the first multimedia output terminal and the second multimedia output terminal is internal to the portable electronic device, and the other is external to the portable electronic device.

In yet another exemplary embodiment, an apparatus for outputting multiple multimedia tracks along multiple processing paths is provided. The method has the following steps of: a processing unit, configured to run a first application and a second application in parallel, and to process a first multimedia track corresponding to the first application and a second multimedia track corresponding to the second application along a first processing path and a second processing path respectively; at least one multimedia codec unit, configured to encode and decode the first multimedia track and the second multimedia track; at least one internal multimedia output terminal, configured to receive and play the first multimedia track from the first processing path; and a transmission interface unit, configured to transmit the second multimedia track from the second processing path to a first external multimedia output terminal.

### BRIEF DESCRIPTION OF THE DRAWINGS

The present invention can be more fully understood by reading the subsequent detailed description and examples with references made to the accompanying drawings, wherein:

FIG. 1 is a schematic diagram illustrating a portable electronic device 100 according to an embodiment of the invention;

FIG. 2 is a diagram illustrating audiovisual content control of application in a conventional portable electronic device;

FIG. 3 is a diagram illustrating audiovisual content control of application in a portable electronic device according to an embodiment of the invention;

FIG. 4A-4C are diagrams illustrating the operations for selecting an output terminal of an application in a user interface according to an embodiment of the invention;

FIG. 5 is a diagram illustrating audiovisual content control of application in a portable electronic device according to another embodiment of the invention;

FIG. 6 is a flow chart illustrating the method for outputting multiple multimedia tracks along multiple processing paths from a portable electronic device according to an embodiment of the invention; and

FIG. 7 is a flow chart illustrating the method for outputting multiple multimedia tracks along multiple processing paths from a portable electronic device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

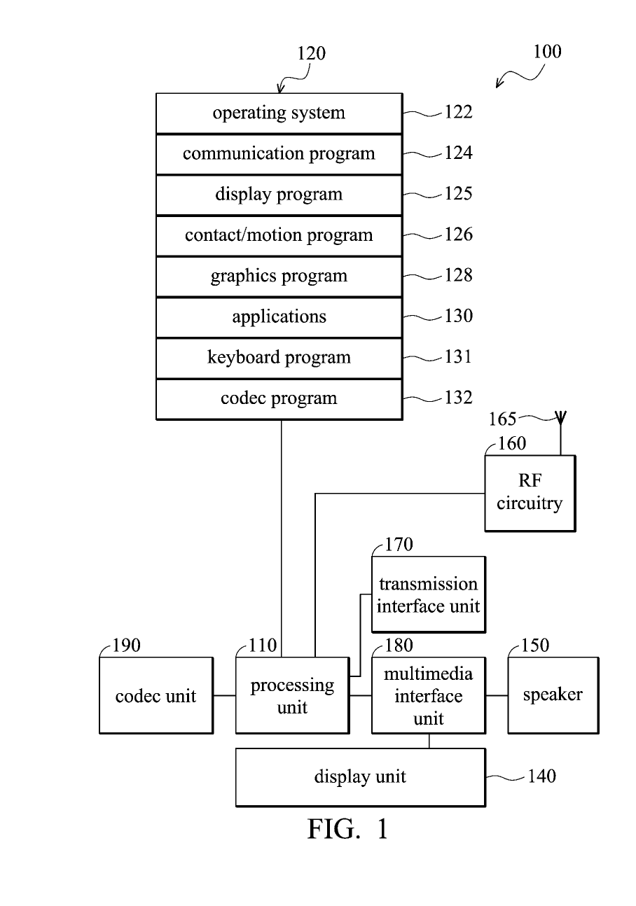

FIG. 1 is a schematic diagram illustrating a portable electronic device 100 according to an embodiment of the invention. The portable electronic device 100 may comprise a processing unit 110, a memory unit 120, a display screen 140, a transmission interface unit 170, a multimedia interface unit 180, and a codec unit 190. In an exemplary embodiment, the portable electronic device 100 may be a portable device such as a mobile phone, tablet, digital camera/camcorder, game console or any suitable device. The processing unit 110 may be data processing units, image processing units, application processing units and/or central processing units, and is capable of executing one or more types of computer readable medium stored in the memory unit 120. Additionally, the portable electronic device 100 may further comprise RF circuitry 160. In the embodiments, the display screen 140 may be a touch-sensitive screen.

The RF circuitry 160 may be coupled to one or more antennas 165 and may allow communications with one or more additional devices, computers and/or servers via a wireless network. The portable electronic device 100 may support various communications protocols, such as the code division multiple access (CDMA), Global System for Mobile Communications (GSM), Enhanced Data GSM Environment (EDGE), High-Speed Downlink Packet Access (HSDPA), Wi-Fi (such as IEEE 802.11a/b/g/n), Bluetooth, and Wi-MAX communication protocol, and a protocol for emails, instant messaging (IM), and/or a short message services (SMS), but the invention is not limited thereto.

When the display screen 140 is implemented as a touch-sensitive screen, it may detect contact and any movement or break thereof by using any of a plurality of touch sensitivity technologies now known or to be later developed, including, but not limited to, capacitive, resistive, infrared, and surface acoustic wave touch sensitivity technologies, as well as other proximity sensor arrays or other elements for determining one or more points of contact with the touch-sensitive screen. However, the touch-sensitive screen may also display the visual output of the portable electronic device 100. In some other embodiments, the portable electronic device 100 may include circuitry (not shown in FIG. 1) for supporting a location-determining capability, such as that provided by a Global Positioning System (GPS).

The memory unit 120 may comprise one or more types of computer readable medium. The memory unit 120 may be high-speed random access memory (e.g. SRAM or DRAM) and/or non-volatile memory, such as flash memory (for example an embedded multi-media card). The memory unit 120 may store program codes of an operating system 122, such as LINUX, UNIX, OS X, Android, iOS or WINDOWS operating system, or an embedded operating system therein such as VxWorks. The operating system 122 may execute procedures for handling basic system services and for performing hardware dependent tasks. The memory unit 120 may also store the communication programs 124 for executing communication procedures. The communication procedures may be used for communicating with one or more additional devices, one or more computers and/or one or more servers. The memory unit 120 may comprise display programs 125, contact/motion programs 126 to determine one or more points of contact and/or their movement, and a graphics processing programs 128. The graphics processing programs 128 may support widgets, i.e., modules or applications with embedded graphics. The widgets may be implemented using JavaScript, HTML, Adobe Flash, or other suitable computer programming languages and technologies.

The memory unit 120 may also comprise one or more application programs 130. For example, application programs stored in the memory unit 120 may be telephone applications, email applications, text messaging or instant messaging applications, memo pad applications, address books or contact lists, calendars, picture taking and management applications, and music playback and management applications. The application programs 130 may comprise a web browser (not shown in FIG. 1) for rendering pages written in the Hypertext Markup Language (HTML), Wireless Markup Language (WML), or other languages suitable for composing web pages or other online content. The memory unit 120 may further comprise keyboard input programs (or a set of instructions) 131. The keyboard input programs 131 operate one or more soft keyboards.

The memory unit 120 may also comprise a codec program 132 for processing audiovisual data generated by the applications 130. For example, the portable electronic device 100 may further comprise a codec unit 190, which may be an application-specific integrated circuit (ASIC) or a DSP, configured to perform encoding/decoding (codec) processes on audiovisual data. The audiovisual data generated by the applications 130 can be processed by hardware (e.g. codec unit 190) or software (e.g. codec program 132 executed by the processing unit 110). Furthermore, the audio/video processing can be performed by hardware and software concurrently.

It should be noted that each of the above identified programs and applications corresponds to a set of instructions for performing one or more of the functions described above. These programs (i.e., sets of instructions) need not be implemented as separate software programs, procedures or modules. The various programs and sub-programs may be rearranged and/or combined. Various functions of the portable electronic device 100 may be implemented in software and/or in hardware, including one or more signal processing and/or application-specific integrated circuits.

The transmission interface unit 170 is configured to transmit audio/video signals generated by the applications 130 to at least one external multimedia terminal (e.g. TV, Bluetooth headset, and etc.) in a wireless network protocol, such as Wifi, Bluetooth, LAN, etc. In addition, transmission of audio/video signals can be implemented by Miracast, DLNA, WiDi, and/or other known standards, and the processing unit 110 may encode the output audio/video signals according to the selected transmission protocol/standard.

The multimedia interface unit 180 may comprise various physical interfaces configured to transmit audio/video signals generated by the applications 130 to local multimedia terminals (e.g. display, speakers, and etc.) which are connected to the portable electronic device 100 via the multimedia interface unit 180.

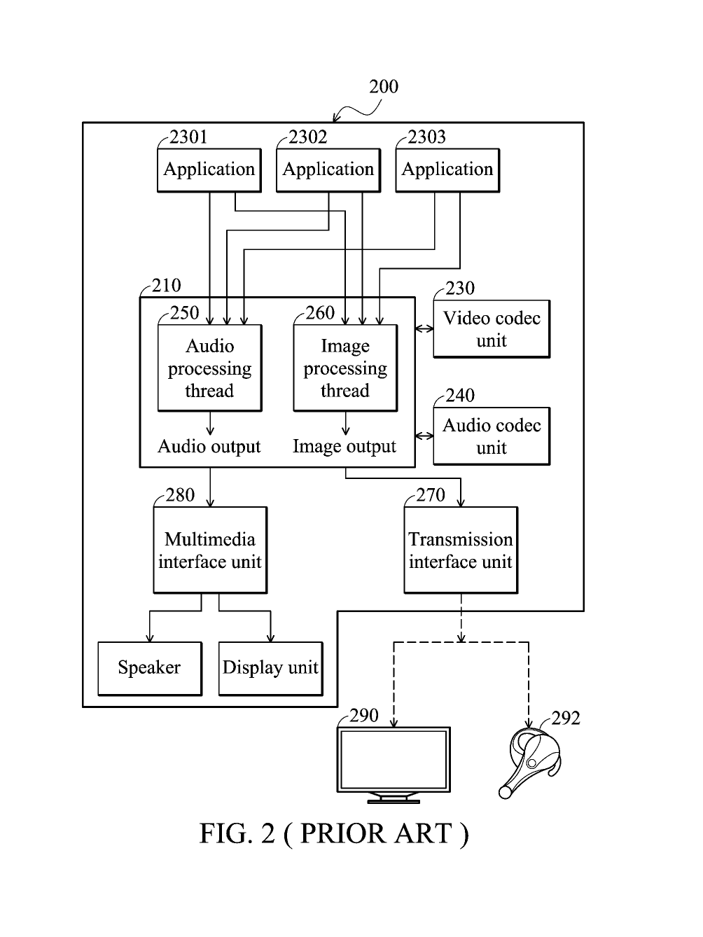

FIG. 2 is a diagram illustrating audiovisual content control of application in a conventional portable electronic device. As illustrated in FIG. 2, an audio processing thread 250 and an image processing thread 260 are executed by the processing unit 210 of the conventional portable electronic device 200. The audio processing thread 250 is configured to perform audio processing of all applications (e.g. applications 2301, 2302 and 2303) running on the conventional portable electronic device 200 with the support of an audio codec unit 240 to generate output audio signals. Similarly, the image processing thread 260 is configured to perform image processing of all applications running on the conventional portable electronic device 200 with the support of a video codec unit 230 to generate output video signals. Accordingly, the audio tracks of all the applications running on the conventional portable electronic device 200 are processed by the same audio processing thread 250 as well as the images of all the applications running on the portable electronic device 200 being processed by the same image processing thread 260.

Specifically, the conventional portable electronic device 200 may support the “Mirror” mode, which indicates that all the output audio/video/image signals of the portable electronic device 200 are transmitted to another external device, such as a TV 290 or Bluetooth headset 292. In other words, there is only one processing path for the audio/video/image signals of the applications running on the portable electronic device 200. However, in the “Mirror” mode, the external device can only display exactly the same content with the conventional portable electronic device 200. Accordingly, the audio/image signals of all the applications running on the conventional portable electronic device 200 cannot be controlled separately and independently.

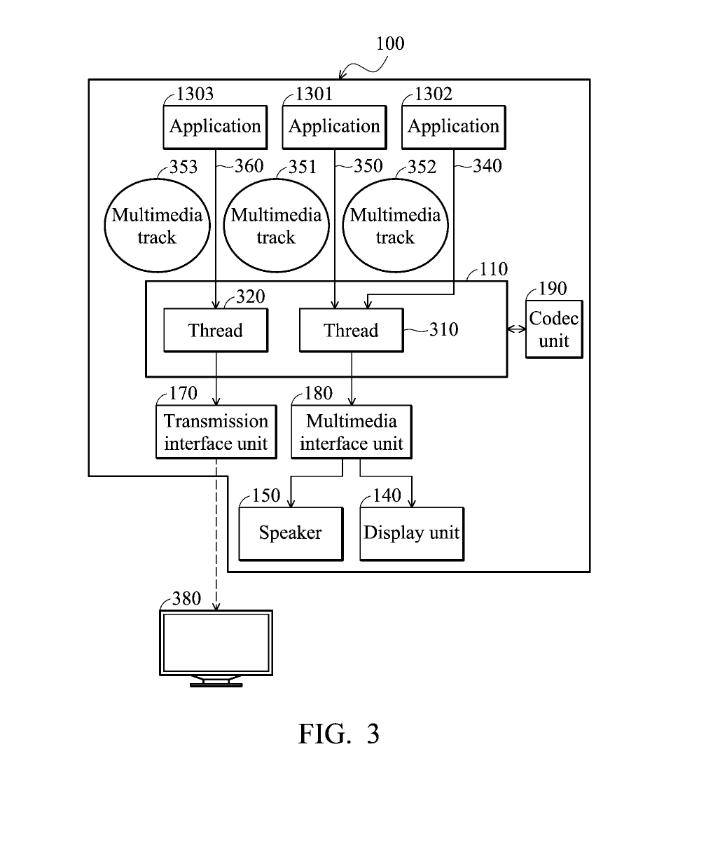

FIG. 3 is a diagram illustrating multimedia content control of application in a portable electronic device according to an embodiment of the invention. As illustrated in FIG. 3, thread 310 and thread 320, which are executed by the processing unit 110, are responsible for processing multimedia tracks generated by the applications 130. The thread 310 and thread 320 may be audio processing threads or image processing threads. In practical implementation, audio signals and video signals are processed separately. However, for a brief description, the thread 310 and thread 320 can be regarded as multimedia processing threads capable of executing codec firmware/codes for processing audio signals, image signals and video signals simultaneously.

In the embodiment of FIG. 3, the processing unit 110 is capable to run multiple threads 310 and 320 concurrently at the same time. Each of the threads 310 and 320 corresponds to one of available multimedia output terminals. Available multimedia terminals may comprise local multimedia output terminals and external multimedia output terminals detected by and connected to the portable electronic device 100. The thread 310 corresponds to a local multimedia output terminal, which may be the speaker 150 for audio playing and display unit 140 for image/video displaying. Since a local multimedia output terminal is always present and used by user, the thread 310 may be executed by the processing unit 110 permanently. The thread 320 corresponds to an external multimedia output terminal, such as TV 380 in FIG. 3, and it can be created only when the TV 380 is detected by and/or connected to the portable electronic device 100. In another embodiment of the invention, the thread 320 can be created when the TV 380 is selected for outputting multimedia tracks of an application even though it has been detected and connected. When an application is running, the multimedia track corresponding to the application is directed to and processed by one of the threads 310 or 320 according to the multimedia output terminal used for outputting the multimedia track. In order to specify which multimedia output terminal is used for outputting the multimedia track of the application, an identifier is attached to the multimedia track. The identifier comprises information about the application and the thread corresponding to the multimedia output terminal. By attaching the identifier, it can be determined whether the multimedia track should be directed to and processed by the thread 310 or the thread 320. For example, the multimedia track 351 of the application 131 is attached with an identifier comprising information specifying the application 1301 and the thread 310. Upon receiving the multimedia track 351, the processing unit 110 would send the multimedia track 351 to the thread 310 accordingly since the identifier indicates that it should be processed by the thread 310. Similarly, the multimedia track 353 is attached with another identifier comprising information about the application 1303 and the thread 320. The multimedia output terminal for outputting multimedia tracks of applications may be selected by user via a user interface, which may be provided on the display unit 140. For example, the local multimedia terminals such as the display unit 140 and the speaker 150 may be set as the default multimedia output terminals. However, the user may choose to output the multimedia track 253 of the application 1303 to the TV 380 via the user interface. In response to the user selection, the identifier attached to the multimedia track 353 would comprise information specifying the thread 320 corresponding to the TV 320 rather than the thread 310.

In an embodiment, the multimedia track (e.g. multimedia track 351) generated by the application 1301 is directed to the thread 310, which performs processes for outputting multimedia tracks to local multimedia output terminals (e.g. touch screen, speaker, and ear jack), via the first processing path 350. In addition, the multimedia track (e.g. track multimedia 353) generated by the application 1303 is directed to the thread 320, which performs processes for outputting multimedia tracks to external multimedia output terminals (e.g. TV 380, or speakers, Bluetooth headset, etc.), via the second processing path 360. Further, the transmission interface unit 170 may receive the output multimedia tracks from the thread 320 and transmit the multimedia tracks to the external multimedia output terminal in a wireless protocol, such as Wifi, Bluetooth, LAN, etc. The transmission of the output multimedia tracks can be implemented by Miracast, DLNA, Widi and/or other known standards, and the output multimedia tracks are encoded by the codec unit 190 based on the selected transmission protocol.

Also note that, multimedia tracks for more than one application may be received and processed by each of the thread 310 and thread 320. In the embodiment of FIG. 3, the thread 310 receives the multimedia track 351 of the application 1301 and multimedia track 352 of application 1302, and processes them to generate an output multimedia track to the multimedia interface unit 180. Put it in simple, multimedia tracks 351 and 352 can be mixed by thread 310 to produce the output multimedia track. In the case for audio tracks, a mixed audio track comprising audio tracks of applications 1301 and 1302 is played by the speaker 150, and in the case for image tracks, a mixed image track comprising images of application 1301 and 1302 is displayed on the display unit 140.

In the embodiment of FIG. 3, thread 310 is responsible for processing the multimedia tracks 351 and 352 to be outputted to local multimedia output terminals, such as the speaker 150 and the display unit 140. Meanwhile, the thread 320 is responsible for processing the multimedia track 353, which is outputted to an external multimedia output terminal, such as the TV 380. The threads 310 and 320 may be run concurrently in parallel by the processing unit 110 for producing multimedia outputted to both local and external multimedia output terminals at the same time. Please note that in other embodiments of the invention, there may be more than two threads running by the processing unit 110 in the case that more than one external multimedia output terminal is connected to the portable electronic device 100. For example, in the case that there are two external TVs connected to the portable electronic device 100, two additional threads may be run by the processing unit 110 in addition to the thread 310. Each of the additional thread corresponds to one of the external TVs and is responsible for processing multimedia tracks to be outputted to the corresponding external TV.

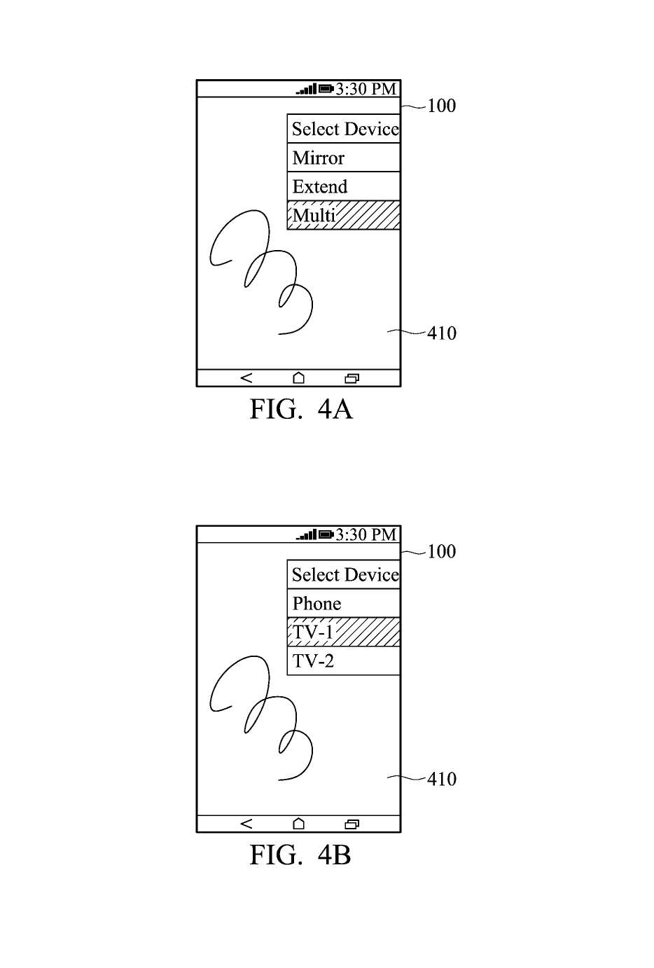

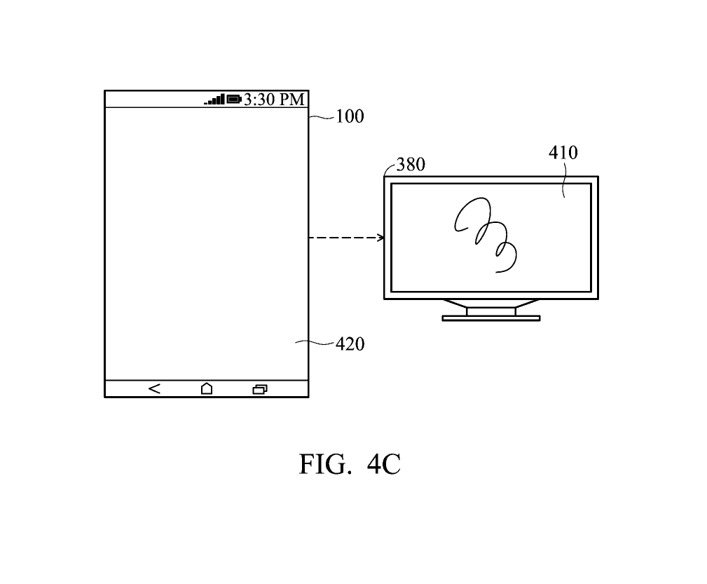

FIG. 4A-4C are diagrams illustrating the operations for selecting an output terminal of an application via a user interface according to an embodiment of the invention. When an application is launched and running, the multimedia track of the application can be outputted to a designated multimedia terminal by selecting one of the output modes via the user interface of the application. For example, as illustrated in FIG. 4A, when the “Mirror” mode is selected, the processing unit 110 may duplicate all the multimedia tracks of the application 410 on the portable electronic device 100 to a TV 380. In another embodiment of the invention, the image contents of the application 410 are displayed on both the display unit 140 and the TV 380, but the audio tracks of the multimedia track of the application 410 are only played by the TV 380. When the “Extend” mode is selected, the processing unit 110 may output image contents to the TV 380, and the portable electronic device 100 can be used as a controller (e.g. a control pad). One exemplary scenario in the “Extend” mode is that the TV is used to display game images, and the portable electronic device 100 is used as a control pad to control contents in the game. When a “Multi” mode is selected, the processing unit 110 may output the content of the application 410 externally to the TV 380. Meanwhile, another application 420 can be executed and displayed on the display unit 140 of the portable electronic device 100 simultaneously as shown in FIG. 4C. In other words, the application 410 may be regarded as a background task while the application 420 is executed as a primary application, which is currently displayed on the display unit 140 of the portable electronic device 100. It should be noted that the application 410 and the application 420 can be running concurrently in parallel.

As illustrated in FIG. 4B, when the user selects the “Multi” mode, the portable electronic device 100 may display a user interface to provide options of available multimedia output terminals, such as “Phone”, “TV-1”, and “TV-2”. When the option “Phone” is selected, it may indicate that the audio and video contents of the application 420 will be directed to the local speaker 150 and the display unit 140 of the portable electronic device 100 respectively. Regarding the options “TV-1” and “TV-2”, it may indicate that TV-1 and TV-2 are external terminals which have been previously paired with and registered to the portable electronic device 100. In addition, the portable electronic device 100 may constantly detect whether any previously paired multimedia terminal can be used for multimedia transmission exists. Furthermore, the portable electronic device 100 may detect whether an unknown multimedia terminal (i.e. not previously paired or registered) appears and can be connected to. In the embodiment, the option “TV-1” is selected for the application 410 and the audio/visual content of the application 410 is transmitted to the TV-1, as illustrated in FIG. 4B. Afterwards, the application 420 can be run and the audio/visual content of the second application 420 can be displayed locally in the portable electronic device 100 while the content of the application 410 is displayed on the TV-1 concurrently, as illustrated in FIG. 4C. It should be noted that the audio/visual data of the first application and the second application are both processed by the portable electronic device 100.

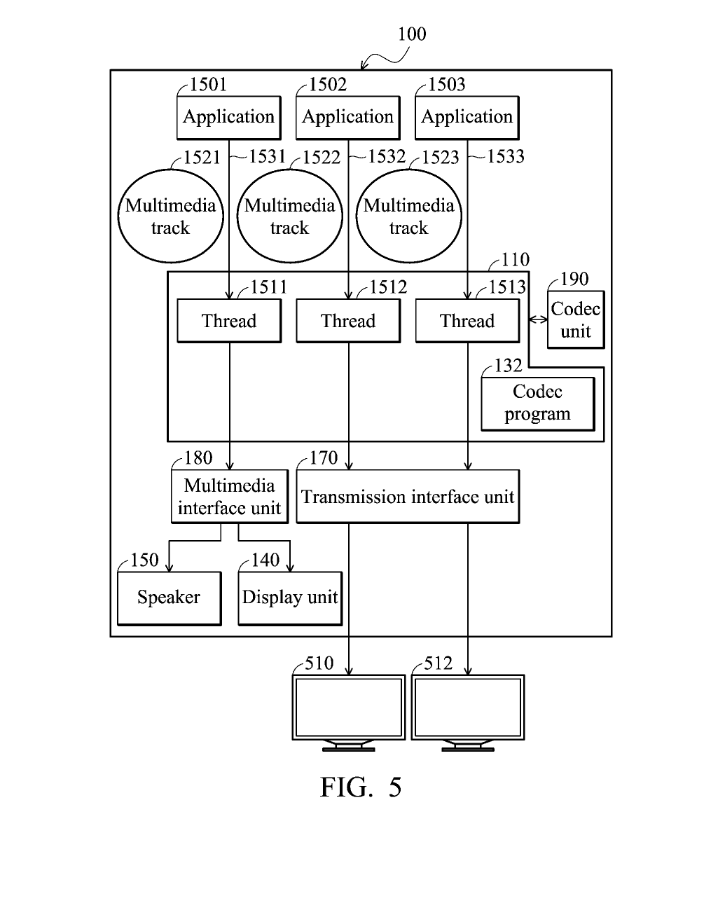

FIG. 5 is a diagram illustrating audio/visual content control of application in a portable electronic device according to another embodiment of the invention. As illustrated in FIG. 5, 3 applications 1501, 1502 and 1503 are running in the portable electronic device 100 concurrently. In addition, three threads 1511, 1512, and 1513 are executed by the processing unit 110 of the portable electronic device 100. Specifically, the multimedia track 1521 corresponding to the application 1501 is directed to the thread 1511 via the first processing path 1531, and the thread 1511 may process the multimedia track 1521 and further transmit the processed multimedia track 1521 to the local display unit 140 and the speaker 150 through the multimedia interface unit 180. The multimedia track 1522 corresponding to the application 1502 is directed to the thread 1512 via the second processing path 1532, and the thread 1512 may process the multimedia track 1522 and further transmit the processed multimedia track 1522 to the TV 510 via the transmission interface unit 170. In addition, the multimedia track 1523 corresponding to the application 1503 is directed to the thread 1513 via the third processing path 1533, and the thread 1513 may process the multimedia track 1523 and further transmit the processed multimedia track 1523 to the TV 512 via the transmission interface unit 170. For example, the hardware codec unit 190 may perform audio/image/video encoding/decoding of the multimedia track 1521, and the software codec program 132 executed by the processing unit 110 may perform audio/image/video encoding/decoding of the multimedia tracks 1522 and 1523. In other embodiments of the invention, the multimedia tracks 1521˜1523 may be encoded and/or decoded solely by the hardware codec unit 190 or the software codec program 132 depending on the system requirements or performance. In yet another embodiment of the invention, the multimedia tracks 1521˜1523 may be processed by the hardware codec unit 190 or the software codec program 132 according to the coding formats supported by the codec unit 190 and the codec program 132. It should be noted that the coordination of hardware/software codec is known to those skilled in the art, and the details will be omitted here.

Similar to the embodiment of FIG. 3, the treads 1511˜1513 may be run concurrently in parallel by the processing unit 110 so as to provide multimedia outputs to the local and external multimedia terminals at the same time. Each of the threads 1511˜1513 corresponds to one of the multimedia terminals. That is, the portable electronic device 100 is capable of running the applications 1501˜1503 and providing contents of the applications to different multimedia terminals at the same time. As described in the embodiments of FIG. 4A˜4C, the user is able to configure which multimedia output terminal to be used to provide output from a designated application via the user interface. Also in other embodiments of the invention, in the case that two or more applications are designated to the same multimedia terminal, the thread corresponding to the multimedia terminal would process multimedia tracks of the applications. Also, the multimedia tracks 1521˜1523 are attached with identifiers comprising information about corresponding applications and threads so that the multimedia tracks 1521˜1523 can be directed to corresponding threads 1511˜1523 correctly.

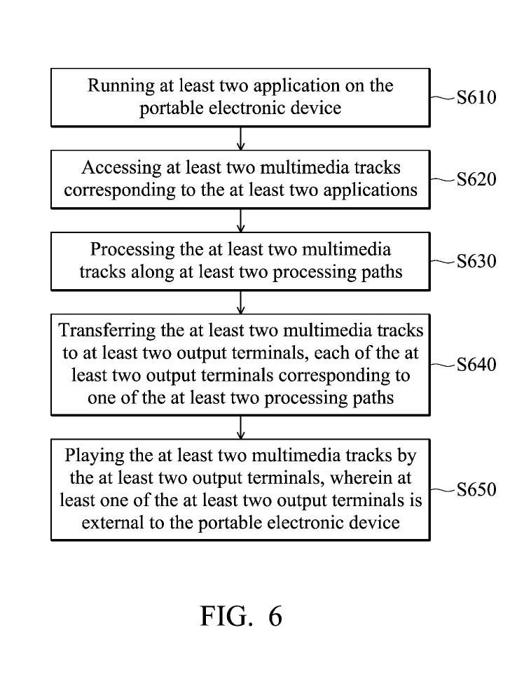

FIG. 6 is a flow chart illustrating the method for outputting multiple multimedia tracks along multiple processing paths from a portable electronic device according to an embodiment of the invention. In step S610, at least two applications are running on the portable electronic device 100. In step S620, the processing unit 110 may access at least two multimedia tracks corresponding to the at least two applications. The multimedia tracks may be accessed from internal memory or external memory, for example from the internet. In step S630, the at least two multimedia tracks are processed along at least two processing paths. It is noted that the processing unit 110 also creates multimedia threads in the first processing paths, and the multimedia tracks are encoded/decoded by a hardware codec unit (e.g. codec unit 190) and/or software codec program (e.g. codec program 132). The processing unit 110 may also attach identifiers to the multimedia tracks for specifying which processing paths they should be directed to. The identifiers comprise information about corresponding applications and multimedia threads, so that the processing unit 110 may direct the multimedia tracks to the corresponding processing paths correctly based on the identifiers.

In step S640, the processing unit 110 may further transfer the multimedia tracks to at least two output terminals. The output terminals may be local terminals and/or external terminals. In the embodiment of the invention, at least one of the output terminals is external to the portable device 100. In step S650, the at least two multimedia tracks can be played by the at least two output terminals. It should be noted that one of the output terminal may be an external output terminal and the other output terminal may be an internal output terminal. Additionally, the processing unit 110 may keep detecting the presence of the at least two output terminals (particularly the external output terminals), and create corresponding processing paths in response to the detected presence of the output terminals. In other words, when there is no external output terminal connected to the portable electronic device 100, the processing unit 110 may not create the processing thread and the processing path associated with the external output terminal. It should be noted that the transmission of the multimedia track to the external output terminal is implemented by one of the following wireless transmission protocols: Wifi (e.g. Wifi Direct or Miracast), Bluetooth, LAN, and/or other suitable protocols. And the multimedia track to be transferred to the external output terminal can be encoded according to the wireless transmission protocol. Please also note that the portable electronic device 100 may provide a user interface to the user. Use may send user input via the user interface for selecting an output terminal to be used for outputting audio/visual content of an application. According to the user input, the processing unit 110 configures the applications so that the multimedia tracks of the applications can be sent to corresponding threads for processing.

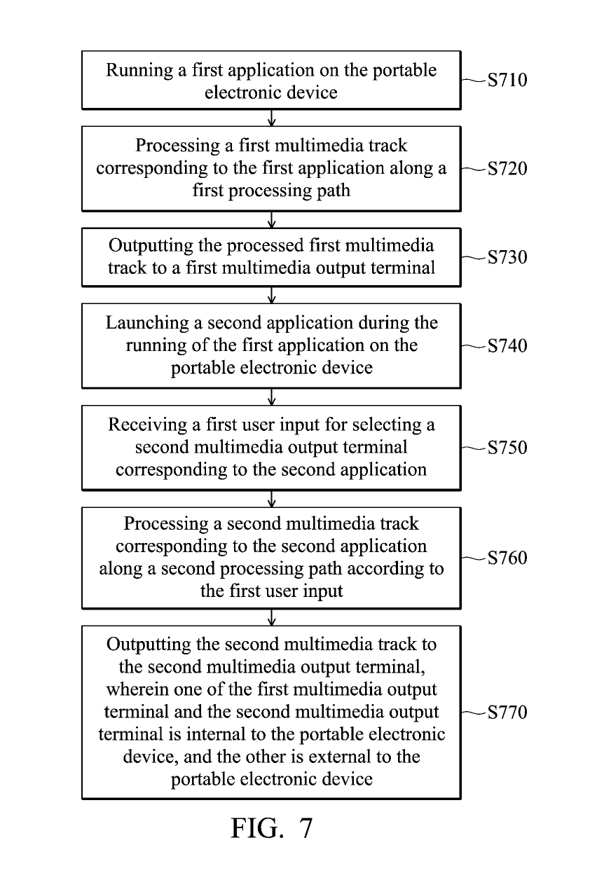

FIG. 7 is a flow chart illustrating the method for outputting multiple multimedia tracks along multiple processing paths from a portable electronic device according to another embodiment of the invention. In step S710, a first application is running on the portable electronic device. In step S720, the processing unit 110 may process a first multimedia track corresponding to the first application along a first processing path. In step S730, the processing unit 110 may further output the processed first multimedia track to a first multimedia output terminal. In step S740, a second application is launched during the running of the first application on the portable electronic device 100. It should be noted that the scenario of FIG. 7 indicates that a new application is launched and run with the existing processing path of a running application. In step S750, a first use input is received via a user interface (e.g. a touch event on the user interface displayed on the display unit 140). The first user input may be used to select a second multimedia output terminal corresponding to the second application. Afterwards, in step S760, the processing unit 110 may process a second multimedia track corresponding to the second application along a second processing path according to the first user input. In step S770, the processing unit 110 may output the second multimedia track to the second multimedia output terminal. It should be noted that one of the first multimedia output terminal and the second multimedia output terminal is internal to the portable electronic device 100, and the other one of the first multimedia output terminal and the second multimedia output terminal is external to the portable electronic device 100. In other words, when the existing processing path is associated with an internal output terminal, the newly created processing path can be directed to an external output terminal. Conversely, when the existing processing path is associated with an external output terminal, the newly created processing path can be directed to an internal output terminal. Additionally, the processing unit 110 may further switch the first multimedia track or the second multimedia track to be processed in another processing path (e.g. the second processing path and the first processing path, respectively) in response to user input (e.g. a touch event on the user interface displayed on the display unit 140).

Specifically, the processing unit 110 may modify the first identifier of the first application to correspond to another processing path associated with a specific output terminal, and then the processing unit 110 may switch the first multimedia track corresponding to the first application to the specific output terminal according to the modified first identifier. Similarly, the processing unit 110 may modify the second identifier of the second application to correspond to another processing path associated with a specific output terminal, and then the processing unit 110 may switch the second multimedia track corresponding to the second application to the specific output terminal according to the modified second identifier. It should be noted that the specific output terminal can be selected from the existing internal/external output terminal or an additional external output terminal. When the selected specific output terminal is exactly the additional external output terminal, the processing unit 110 may create a third processing path (in addition to the first/second processing paths) to process switching of the first/second multimedia tracks. Also similarly to the embodiment of FIG. 6, in the case that the multimedia track is to e outputted to an external output terminal, the multimedia track can be encode by suitable transmission protocol.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine such as a computer, the machine becomes an apparatus for practicing the disclosed methods. When implemented on a general-purpose processing unit, the program code combines with the processing unit to provide a unique apparatus that operates analogously to application-specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for outputting multiple multimedia tracks along multiple processing paths from a portable electronic device, comprising:
running at least two applications on the portable electronic device;
accessing at least two multimedia tracks corresponding to the at least two applications;
processing the at least two multimedia tracks along at least two processing paths;
transferring the at least two multimedia tracks to at least two output terminals, each of the at least two output terminals corresponding to one of the at least two processing paths; and
playing the at least two multimedia tracks by the at least two output terminals;
wherein at least one of the at least two output terminals is external to the portable electronic device.

2. The method of claim 1, further comprising:
creating at least two multimedia threads in the at least two processing paths;
attaching identifiers to the at least two multimedia tracks, wherein the identifiers comprise information about corresponding applications and multimedia threads;
directing the at least two multimedia tracks to the at least two processing paths according to the identifiers; and
processing the at least two multimedia tracks by corresponding multimedia threads.

3. The method of claim 1, further comprising:
providing a user interface for receiving a user input for selecting at least one of the output terminals for a selected one of the at least two applications; and
selecting one of the at least two processing paths for processing the selected application according to the user input.

4. The method of claim 1, further comprising:
determining presence of the at least two output terminals; and
creating corresponding processing paths according to the presence of the at least two output terminals being determined.

5. The method of claim 1, further comprising:
accessing a third multimedia track of a third application running on the portable electronic device;
processing the third multimedia track along a selected one of the at least two processing paths; and
playing the third multimedia track by the output terminal corresponding to the selected processing path;
wherein the selected processing path corresponds to the output terminal internal to the portable electronic device.

6. The method of claim 1, further comprising:
accessing a third multimedia track of a third application running on the portable electronic device;
processing the third multimedia track along a third processing path; and
transferring the third multimedia track to a third output terminal,
wherein the third output terminal is external to the portable electronic device.

7. The method of claim 1, wherein transferring of the at least two multimedia tracks further comprises:
transferring the multimedia track along the processing path corresponding to the output terminal external to the portable electronic device in a wireless transmission protocol, and the wireless transmission protocol is selected from one of the following protocols: WiFi, Bluetooth, and LAN.

8. The method of claim 7, further comprising:
encoding the multimedia track according to the selected wireless protocol.

9. A method for outputting multiple multimedia tracks along multiple processing paths from a portable electronic device, comprising:
running a first application on the portable electronic device;
processing a first multimedia track corresponding to the first application along a first processing path;
outputting the processed first multimedia track to a first multimedia output terminal;
launching a second application during the running of the first application on the portable electronic device;
receiving a first user input for selecting a second multimedia output terminal corresponding to the second application;
processing a second multimedia track corresponding to the second application along a second processing path according to the first user input; and
outputting the second multimedia track to the second multimedia output terminal,
wherein one of the first multimedia output terminal and the second multimedia output terminal is internal to the portable electronic device, and the other is external to the portable electronic device.

10. The method of claim 9, further comprising:
receiving a second user input for selecting the first multimedia output terminal corresponding to the first application.

11. The method of claim 9, wherein the outputting of the multimedia track to the multimedia output terminal external to the portable electronic device further comprises:
encoding the multimedia track according to a wireless transmission protocol; and
outputting the multimedia track to the multimedia output terminal external to the portable electronic device via wireless transmission;
wherein the wireless transmission is implemented by one of the following protocols: WiFi, Bluetooth, and LAN.

12. The method of claim 9, further comprising:
attaching a first identifier to the first multimedia track;
attaching a second identifier to the second multimedia track; and
directing the first multimedia track and the second multimedia track to the first processing path and the second processing path respectively according to the first identifier and the second identifier;
wherein the identifiers comprise information about corresponding applications and multimedia output terminals.

13. The method of claim 12, further comprising:
receiving a second user input for switching the first multimedia track to another multimedia output terminal;
modifying information of the identifier of the first multimedia track according to the second user input; and
directing the first multimedia track to another processing path corresponding to the switched multimedia output terminal according to the modified identifier;
wherein the switched multimedia output terminal is selected from the second output terminal and at least one third multimedia output terminal connected to the portable electronic device.

14. The method of claim 9, further comprising:
receiving a second user input for switching the first multimedia track to another multimedia output terminal; and
processing the first multimedia track by another processing path corresponding to the switched multimedia output terminal,
wherein the switched multimedia output terminal is selected from the second output terminal and at least one third multimedia output terminal connected to the portable electronic device.

15. The method of claim 14, further comprising: processing the first multimedia track by a third processing path corresponding to the third multimedia output terminal in response to the switched multimedia output terminal being the third multimedia output terminal.

16. An apparatus for outputting multiple multimedia tracks along multiple processing paths, comprising:
a processing unit, configured to run a first application and a second application in parallel, and to process a first multimedia track corresponding to the first application and a second multimedia track corresponding to the second application along a first processing path and a second processing path respectively;
at least one multimedia codec unit, configured to encode and decode the first multimedia track and the second multimedia track;
at least one internal multimedia output terminal, configured to receive and play the first multimedia track from the first processing path; and
a transmission interface unit, configured to transmit the second multimedia track from the second processing path to a first external multimedia output terminal.

17. The apparatus of claim 16, wherein the processing unit is further configured to create a first processing thread and a second processing thread in the first processing path and the second processing path respectively,
wherein the first processing thread corresponds to the internal multimedia output terminal and the second processing thread corresponds to the first external multimedia output terminal.

18. The apparatus of claim 17, wherein the processing unit is further configured to attach a first identifier to the first multimedia track and attach a second identifier to the second multimedia track, and the first identifier and the second identifier comprise information about corresponding applications and multimedia output terminals,
wherein the first multimedia track and the second multimedia track are directed to the first processing path and the second processing path according to the first identifier and the second identifier, respectively.

19. The apparatus of claim 16, wherein the transmission interface unit is further configured to transmit the second multimedia track to the external multimedia output terminal in a wireless transmission protocol, and the multimedia codec unit is further configured to encode the second multimedia track transmitted to the external multimedia output terminal according to the wireless transmission protocol.

20. The apparatus of claim 16, further comprising: a display unit configured to receive a first user input for selecting the first external multimedia output terminal corresponding to the second application, wherein the processing unit is further configured to attach an identifier to the second multimedia track according to the first user input, and direct the second multimedia track to the second processing path according to the identifier.

21. The apparatus of claim 20, wherein the display unit is further configured to receive a second user input for switching the second multimedia track of the second application to another multimedia output terminal, and wherein the processing unit is further configured to modify the identifier of the second application according to the second user input, wherein the other multimedia output terminal is selected from the internal multimedia output terminal and at least a second external multimedia output terminal connected to the portable electronic device.

22. The apparatus of claim 16, wherein the first multimedia track and the second multimedia track comprise at least one of the following: audiovisual data, video data, image data, and audio data.
